(19) United States
(12) Patent Application Publication
(10) Pub. No.: US 2012/0319657 A1
(43) Pub. Date: Dec. 20, 2012

(54) BATTERY MANAGEMENT SYSTEM

(75) Inventors: Jingbo Ke, San Jose, CA (US); Guoxing Li, Sunnyvale, CA (US)

(73) Assignee: O2 Micro USA, Santa Clara, CA (US)

(21) Appl. No.: 13/479,731

(22) Filed: May 24, 2012

Related U.S. Application Data
(60) Provisional application No. 61/497,711, filed on Jun. 16, 2011.

(51) Int. Cl. H02J 7/00

(52) U.S. Cl. 320/134

(57) ABSTRACT

A battery system and method is disclosed The battery system includes a plurality of battery modules configured to receive a current from a power supply and further configured to store and provide electrical energy from the power supply to a load. Each of the plurality of battery modules includes at least one battery and battery management circuitry (BMC) configured to monitor and detect data received from the at least one battery. The battery system further includes central control circuitry (CCC) configured to receive the data from each BMC. The control circuitry is configured to balance each of the plurality of the battery modules, wherein the control circuitry is configured to independently charge or discharge the at least one battery of each of the plurality of battery modules based on the data received from the BMC of each of the plurality of battery modules.

### CROSS-REFERENCE TO RELATED APPLICATIONS

The present application claims the benefit of priority to U.S. Provisional Application Ser. No. 61/497,711 filed Jun. 16, 2011, all of which is incorporated herein by reference in its entirety.

### FIELD

The present disclosure relates to batteries and, more particularly, to battery management.

### BACKGROUND

Battery systems may include a plurality of battery modules coupled together in order to provide relatively high energy for Electric Vehicles (EVs) and/or Hybrid Electric Vehicles (HEVs). EVs and/or HEVs may require the use of a plurality of battery modules in order to meet total voltage and/or current capacity requirements, and to supply power to auxiliary systems. The battery modules generally provide power for propelling the vehicle and powering the various electrical systems used by the driver and other vehicle occupants.

While the use and adoption of battery powered vehicles has numerous advantageous, it can also present challenges in the form of additional design considerations, particularly with regard to the charging and discharging of the battery modules. For example, individual batteries in the battery modules may not have the same capacity. Deviations in capacity may occur due to, for example, different manufacturing processes, chemistry differences, age, etc. Batteries used for EVs and HEVs may include several cells arranged in series in order to achieve higher operating voltages, for example 200 to 300 Volts or more. These batteries are particularly vulnerable to failure. Multi-cell batteries may be subject to a higher failure rate than single cell batteries, due to the larger number of cells used in multi-cell batteries. Problems can be compounded if parallel battery cells are required to achieve desired capacity or power levels.

In some designs, battery modules may be arranged in a direct series configuration and may supply the load; these designs may be used in vehicle systems. This configuration may require that all of the battery modules have the same capabilities and characteristics during their charging and/or discharging periods. If the battery modules are not balanced, i.e., if there are any differences in characteristics and/or capabilities between batteries, performance of the battery modules may be affected. Due to production tolerances, uneven temperature distribution, differences in the aging characteristics of particular cells, etc., it may be possible that individual battery cells in a series chain could become overstressed leading to premature failure of the cell.

In an effort to maximize the energy output of a battery module, batteries may be “overcharged” in order to ensure that the batteries have been charged to at least the minimum level of the battery with the highest capacity, thereby causing an overcharge of those batteries with a lower capacity. For example, during the charging cycle, if there is a degraded battery cell in a chain of battery cells, there is a possibility that once the degraded cell has reached full charge, the cell will be subject to overcharging until the rest of the cells in the chain reach their full charge. This may result in temperature increase and/or pressure build up in the battery modules, resulting in possible damage to the cell. This overcharging can produce undesirable effects such as decreasing overall battery life.

Similarly, undercharging is undesirable because the battery module efficiency may be reduced and battery life can also be prematurely shortened. During discharging, the weakest cell of a battery will may have the greatest depth of discharge and may tend to fail before the other cells of the battery. It may be possible for the voltage on the weaker cells to be reversed as they become fully discharged before the rest of the cells also resulting in early failure of the cell. With every charge cycle and discharge cycle, the weaker cells may continue to get weaker until the battery ultimately fails. In addition, minor variations in the state-of-charge for the different batteries or battery modules can lead to inefficient energy distribution and to more frequent charging cycles, which also tends to shorten the life of the batteries.

As a result of the issues described above, the maximum capacity or 100% of the power from each battery or battery module may not be properly supplied to the load(s). Due to the fact that every battery cell's voltage and capability may vary slightly during a discharging cycle, some batteries may complete the discharge cycle while other batteries have not completely discharged and may still have remaining power. This issue may intensify if the batteries are not fully charged.

In addition, a battery-powered vehicle may present unique hazards when they are involved in an accident or when they have to be serviced or repaired. For instance, due to safety precautions, batteries of different types, capacities, ages, etc. should not be mixed. When a single battery of a plurality of batteries needs to be maintained or serviced, all of the batteries in the group may have to be maintained, which may tend to shorten the life of the batteries. The high voltage batteries and power components may create a potential shock hazard when being handled.

### SUMMARY

In an embodiment, a system is disclosed by the present disclosure. The system includes a power supply, a plurality of battery modules, and central control circuitry. The plurality of battery modules is configured to receive, store electrical energy from said power supply, and provide said electrical energy to a load. Each of the plurality of battery modules comprises at least one battery, and battery management circuitry configured to monitor and detect data received from said at least one battery. The central control circuitry is configured to receive data from each BMC of each of said plurality of battery modules and determine at least one requirement of said at least one battery of each of said plurality of battery modules based on the data received from each BMC.

In a different embodiment, a battery module configured to receive and store electrical energy from a power supply and to provide said electrical energy to a load is disclosed by the present disclosure. The battery module comprises at least one battery and battery management circuitry. The battery management circuitry is configured to monitor and detect data received from said at least one battery. The battery management circuitry is configured to provide the data to central control circuitry. The central control circuitry is configured to determine at least one requirement of said at least one battery of each of said battery module based on the data received from the battery management circuitry.

In yet another embodiment, a method of balancing a plurality of battery modules is disclosed. The method comprises: supplying electrical energy to a plurality of battery modules configured to store and provide said electrical energy to a load, each of said plurality of battery modules comprising at least one battery and battery management circuitry configured to monitor and detect data received from said at least one battery; monitoring said at least one battery of each of said plurality of battery modules via said battery management circuitry of each of said plurality of battery modules; detecting, via said battery management circuitry of each of said plurality of battery modules, data received from said at least one battery of each of said plurality of battery modules; providing, via said battery management circuitry of each of said plurality of battery modules, t he data to central control circuitry; and determining, via said central control circuitry, requirements of said at least one battery of each of said battery module based on the data received from each battery management circuitry.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram of an embodiment of a system consistent with the present disclosure;

FIG. 2 is a block diagram of another embodiment of a system consistent with the present disclosure;

FIG. 3 is a block diagram of an example of a switching regulator circuitry, consistent with the present disclosure; and

FIG. 4 is a block diagram of one example of a battery module for the system, consistent with the present disclosure.

### DETAILED DESCRIPTION

In general, the present disclosure provides a battery system configured to supply energy for EVs and/or HEVs. The battery system may include a plurality of battery modules coupled together in parallel and/or series, depending on the load requirements. Each module may include a plurality of battery cells and control circuitry configured to monitor a status of the battery cells and to communicate the status to a control unit. Each battery module can be charged and discharged independently of other modules via the circuitry and control unit. A system consistent with the present disclosure may provide balancing of the batteries and/or battery modules resulting in a more accurate means of controlling the charge voltage for each battery of a group of batteries used in an electric vehicle. As a result, the system may prevent possible overcharging and/or undercharging of a battery, resulting in an increase in the life of the battery as well as increased potential utilization of the power of each battery. Principles of the embodiments described herein may also be applied to provide balancing of batteries and/or battery modules used in other applications in addition to usage in electric vehicles.

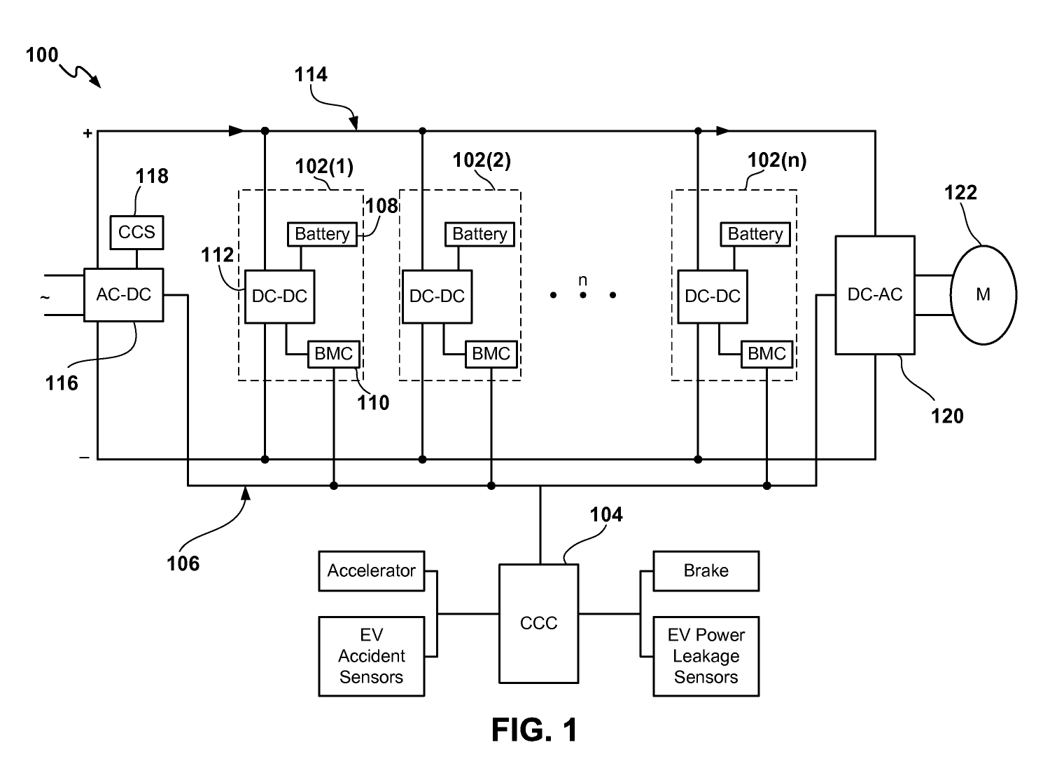

FIG. 1 is a block diagram of an exemplary system 100 in accordance with an embodiment of the present disclosure. The system 100 may include a plurality of battery modules 102(1), 102(2), . . . , 102(n) arranged in a parallel configuration. For ease of description, an individual battery module that may be any of the plurality of battery modules will be referred to herein as “battery module 102”. In the illustrated embodiment, each battery module 102 may include at least one battery 108. The battery 108 may include Lithium-Ion, NiMH (Nickel-Metal Hydride), Lead Acid, Fuel Cell, Super Capacitor, and/or other known or after-developed energy storage technology. Each battery module 102 may also include battery management circuitry (BMC) 110. The BMC 110 may be configured to monitor a status of the battery module 102 as a whole and/or each individual battery 108. Each battery module 102 may further include a bi-directional DC/DC converter 112 coupled to the battery 108 and BMC 110. The DC/DC converter 112 may be configured to be controlled by the BMC 110 to adjust the charging and/or discharging of the battery 108 via instructions from the BMC 110.

The BMC 110 may be coupled to a central control circuitry (CCC) 104 via an electrical connection 106. The electrical connection 106 may be configured to provide communication between the CCC 104 and each BMC 110 of each battery module 102. The electrical connection 106 may be a serial bus configured for serial communication or any other type of electrical connection able to facilitate communication between BMC 110 and CCC 104. One or more messages may be communicated between the CCC 104 and one or more of the BMCs 110 using the electrical connection 106. A message may include commands, e.g., instructions, identifier(s) and/or data.

Each battery module 102 may be connected to a power supply 116 configured to convert alternating current (AC) line voltage to direct current (DC) voltage, such as a rectifier. Each battery module 102 and battery 108 may be connected and configured to provide electrical energy, e.g., current, to a load 122. The load 122 may be a motor M, for example, an electric motor or system associated with an EV or HEV, or any other type of load 122 capable of providing power or energy. Each battery module 102 may be connected to an electrical device configured to convert DC to AC, e.g., an inverter 120. A charge control system (CCS) 118, may be coupled to the power supply 116. The CCS 118 may be configured to regulate the rate at which electric current from the power supply 116 is added to or drawn from each battery module 102. The CCS 118 may be configured to prevent overcharging, overvoltage, and/or deep discharging of each battery module 102.

The BMC 110 may be configured to detect data received from the battery 108. The data may include an indication of a voltage, a discharge current, a charging current, a state-of-charge, and/or a depth-of-discharge from the battery 108. The BMC 110 may be configured to provide a message(s) or data from the battery 108 to the CCC 104 and receive and store data messages from the CCC 104. The BMC 110 may include memory (not shown) for storing the data.

When a battery module 102 is in a charging period, the BMC 110 may be configured to detect data associated with each battery module 102. The data may include an indication of a voltage, a current, a state-of-charge, and a depth-of-discharge from the battery 108, wherein the current is one of a battery discharge current or a battery charging current. The BMC 110 may be configured to provide a signal containing data, which may include the charging current, voltage, and/or state-of-charge of the battery 108, to the CCC 104. Upon receiving the signal containing the battery data, the CCC 104 may be configured to calculate charging requirements for the battery 108. The CCC 104 may be configured to compare the charging requirements with the current charge supplied to the battery 108 via the power supply 116. In addition, the CCC 104 may be configured to compare the charging requirements with the current load required of the motor 122. The CCC 104 may further be configured to re-calculate actual charging current and voltage of each battery 108 and to provide a signal containing such data (actual charging current and voltage) to the BMC 110. Upon receiving the signal from the CCC 104, the BMC 110 may be configured to control the DC/DC converter 112 based on the command from the CCC 104. The DC/DC converter 112 may be configured to adjust the charging current to the battery 108 in response to the data sent from the CCC 104, the data being actual charging current and voltage. A method of adjusting the charging current supplied to the battery 108 is discussed in more detail below.

When a battery module 102 is in a discharging period, the BMC 110 may be configured to provide a signal containing data, including the voltage and depth-of-discharge of the battery 108, to the CCC 104. Upon receiving the battery data, the CCC 104 may be configured to determine an amount of power requested by the load 122 from the battery 108. The CCC 104 may be configured to compare the detected voltage and depth-of-discharge of the battery 108 with the power request from the load 122, and the CCC 104 may determine how much power is needed from the battery 108 to supply to the load 122. The CCC 104 may further be configured to provide a signal containing such data (determination of how much power required from battery to supply load) to the BMC 110. Upon receiving the signal from the CCC 104, the BMC 110 may be configured to control the DC/DC converter 112 based on the command from the CCC 104. The DC/DC converter 112 may be configured to adjust the discharging current and voltage from the battery 108 to the load 122 in response to the command sent from the CCC 104.

The BMC 110 and the CCC 104 may be configured to exchange message(s) over a set period of time. In an embodiment, the BMC 110 and CCC 104 may be configured to exchange message(s) in the range of every 100 to 500 milliseconds. In the event that the BMC 110 does not receive a message(s) from the CCC 104 within the set period of time, the BMC 110 may be configured to determine a communication failure and, in turn, control the DC/DC converter 112 to adjust output of the battery 108 to a known safe voltage/power level, e.g., a 12V/1 W.

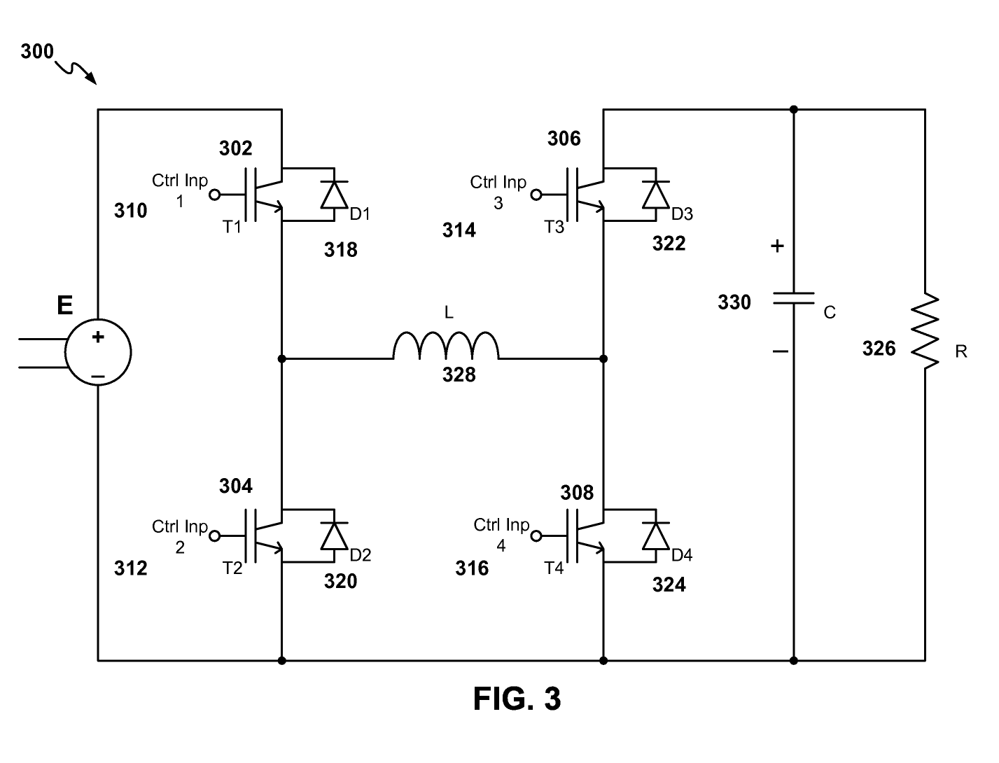

The BMC 110 may further be configured to detect the status of cell(s) (shown in FIG. 3) of the battery 108 and the DC/DC output current and/or voltage in real-time. In the event that the BMC 110 detects any damage to one or more cells of the battery 108, the BMC may be configured to disconnect DC/DC output of the battery module 102 and/or discontinue providing message(s) to the CCC 104 concerning the battery module 102. The BMC 110 may also be configured to determine whether the output current and/or voltage of the battery module 102 exceeds a maximum setting value, and in turn, control the DC/DC converter 112 to adjust output of the battery 108 to a known safe voltage/power level, e.g., a 12V/1 W.

In an embodiment, the CCC 104 may be connected to other systems of a vehicle other than a motor, or to other systems requiring power or energy. For example, the CCC 104 may be connected to an accelerator system (Accelerator), an accident sensor system (EV Accident Sensors), a brake system (Brake), and/or a power leakage sensor system (EV Power Leakage Sensors). The CCC 104 may be configured to implement a failure mode and/or effects analysis in the event that there is a failure of any one of the systems described above. In turn, the CCC 104 may be configured to provide data to each BMC 110 of each battery module 102 and to provide each BMC 110 with a message(s) indicating any such failure of a particular system. The BMC 110 may be configured to determine appropriate current and/or voltage input and/or output to and from each battery 108 in response to failure(s) of a system(s).

For example, the CCC 104 may be configured to detect the occurrence of an accident via the Accident Sensors. In the event that an accident has occurred, the CCC 104 may be configured to provide message(s) to each BMC 110 of each battery module 102. In response to the message(s), each BMC 110 may be configured to control the DC/DC converter 112 to suspend output of each battery 108. Additionally, the CCC 104 may be configured to detect the occurrence of a power leakage via the EV Power Leakage Sensors. In the event that power leakage has occurred, the CCC 104 may be configured to provide message(s) to each BMC 110 of each battery module 102. In response to the message(s), each BMC 110 may be configured to control the DC/DC converter 112 to adjust output of each battery 108 to a known safe voltage/power level, e.g., a 12V/1 W. In addition, the CCC 104 may be configured to detect when the EV is accelerating and/or braking via the Accelerator and/or Brake. In the event that the EV is accelerating and/or braking, indicative of driving mode, the CCC 104 may be configured to provide message(s) to each BMC 110 of each battery module 102. In response to the message(s), each BMC 110 may be configured to control the DC/DC converter 112 to adjust output of each battery 108 to a known safe voltage/power level, e.g., a 12V/1 W.

In the event that only a low amount of power output is required from batteries, e.g., EV is stationary and auxiliary devices, such as air conditioning, are not running, the CCC 104 may be configured to enter an energy “safe mode”. In this mode, the CCC 104 may be configured to control the most capable battery module 102 to provide the low voltage required power and output from all other battery modules is prevented. In the event that more power is required from the batteries, the CCC 104 may be configured to allow the other battery modules to provide power output to the load.

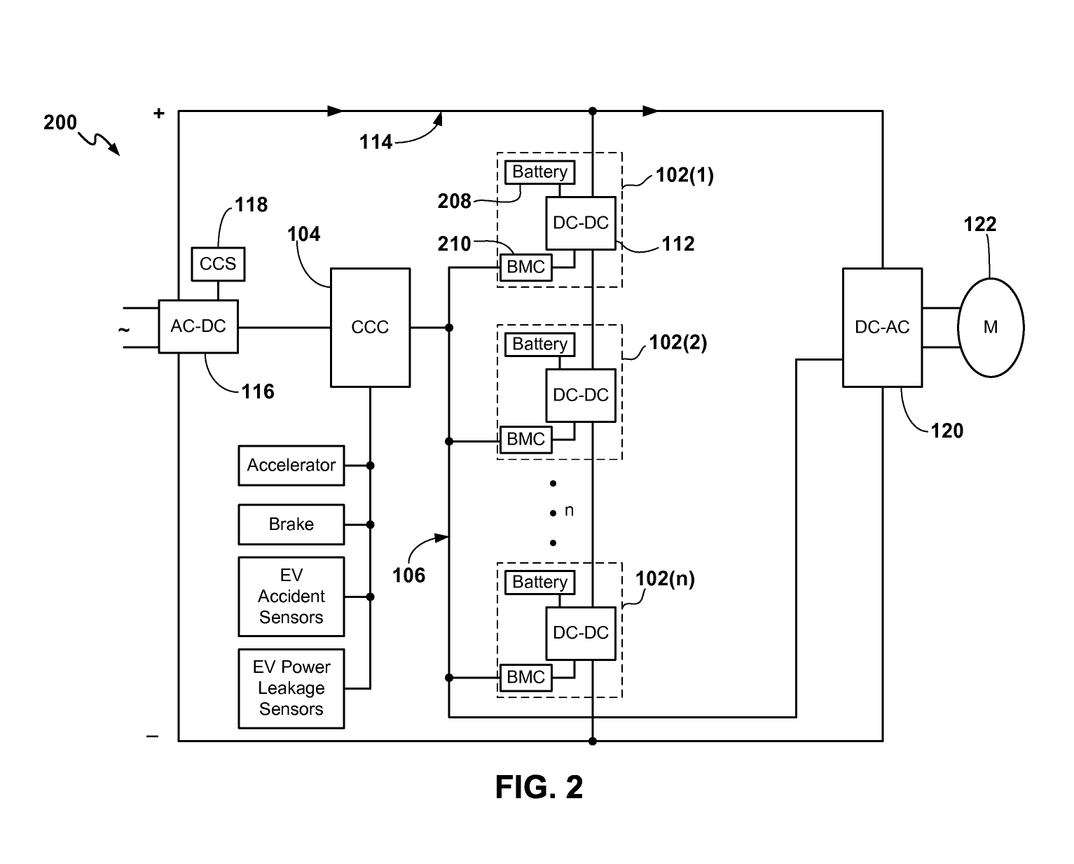

FIG. 2 is a block diagram of another embodiment of a system 200 in accordance with an embodiment of the present disclosure. In each of the systems 100, 200, common elements are assigned common reference designators. The systems 100, 200 include similar elements but differ in configuration of those elements, as described herein. Similar to the system 100 of FIG. 1, system 200 may include a plurality of battery modules 102(1), 102(2), . . . , 102(n). However, unlike the parallel configuration shown in system 100, the battery modules of system 200 are arranged in a serial configuration. All other elements of system 200 may be similar in function and configuration to elements of system 100.

FIG. 3 is a block diagram of an example of a switching regulator circuitry 300 in accordance with an embodiment of the present disclosure. As described above, battery modules may include a bi-directional DC-to-DC converter. The DC/DC converter may be a known step-down (buck) converter or a known step-up (boost) converter. The term “step-down converter” generally refers to a DC-to-DC converter where the output voltage is lower than the input voltage. The term “step-up converter” generally refers to DC-to-DC converter where the output voltage is higher than the input voltage. In an embodiment, the circuitry 300 of the DC/DC converter of FIGS. 1 and/or 2 may be a known step-up/down (boost/buck) converter.

The circuitry 300 may include one or more transistors 302, 304, 306, and 308, e.g., T1, T2, T3, T4, arranged in a four-leg composition. In the illustrated embodiment, the transistors 302, 304, 306, and 308, T1-T4 may be bipolar junction transistors (BJTs). In other embodiments, the transistors may be field-effect transistors (FETS). The transistors T1-T4 may each be connected to a respective control input 310, 312, 314, and 316, Ctrl Inp 1, Ctrl Inp 2, Ctrl Inp 3, Ctrl Inp 4. The control inputs may be connected to a BMC 110. The circuitry 300 may also include one or more diodes 318, 320, 322, and 324, e.g., D1, D2, D3, D4, connected to the respective transistors 302, 304, 306, and 308, T1-T4 and at least one resistor 326, e.g., R. The circuitry 300 may also include an inductance 328 L configured to store energy in the circuit 300 and a capacitance 330 C, wherein the DC side of C may include a DC filter.

The circuitry 300 may be configured to provide a forward-buck, a forward-boost, a reverse-buck, and/or a reverse-boost working state(s). The switches or transistors 302, 304, 306, and 308, T1, T2, T3, and/or T4 may be configured to be in Control On/Off, On, and/or Off states. As used herein, the term “Control On/Off” in the context of a switch may refer to, for example, pulse-width modulation (PWM). The term “On” in the context of a power switch may refer to the resistance of the switch being near zero with very little power dropped in contacts. The term “Off” in the context of a power switch may refer to the resistance of the switch being extremely high and less power being dropped in contacts. The relationships of the On/Off modes of switches T1-T4 with working status of the DC/DC converter are shown in Table 1.

TABLE 1
Relationship of switch mode and working
status of a DC/DC converter

| T1 | T2 | T3 | T4 | Working Status |
|---|---|---|---|---|
| Control | Off | Off | Off | Forward Buck |
| On/Off | | | | |
| On | Off | Off | Control | Forward Boost |
| | | | On/Off | |
| Off | Off | Control | Off | Reverse Buck |
| | | On/Off | | |
| Off | Control | On | Off | Reverse Boost |
| | On/Off | | | |

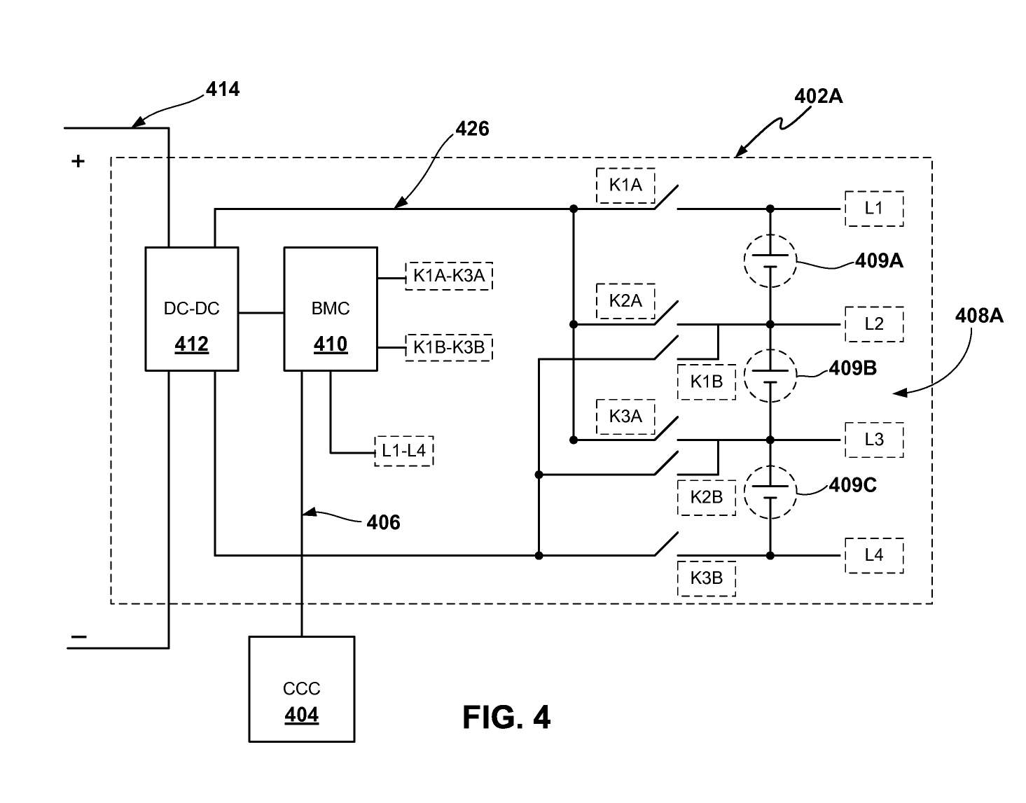

FIG. 4 is a block diagram of a battery module 402A in accordance with an embodiment of the present disclosure. In an embodiment, the battery module 402A may include a battery 408A including a plurality of battery cells 409A, 409B, 409C. The battery module 402A may be connected via a power circuit 414 to an internal and/or external power supply (not shown) and/or a load (also not shown).

Similar to embodiments described above, the battery module 402A may include a BMC 410. The BMC 410 may be coupled to the battery 408A, and, more particularly, to each of the cells 409A, 409B, 409C via a DC/DC converter 412. The DC/DC converter 412 may be coupled to the battery 408A and the cells 409A, 409B, and 409C. The DC/DC converter 412 may be configured to be controlled by the BMC 410 and to adjust the charging and/or discharging of the battery 408A and cells 409A, 409B, and 409C, via instructions from the BMC 410.

The BMC 410 may be configured to balance each of the cells 409A-409C of the battery 408A. For example, when the battery module 402A is in a charging period, the BMC 410 may be configured to detect data from each of the cells 409A-409C, wherein the data may include current, voltage, and/or state-of-charge. The BMC 410 may be configured to determine whether one or more of the cells 409A-409C is unbalanced from the detected data. The BMC 410 may further be configured to calculate appropriate current and/or voltage for the balancing of the cell(s) 409A-409C. Upon calculating appropriate current and/or voltage, the BMC 410 may be configured to control the DC/DC converter 412 based on the calculation. The DC/DC converter 412 may be configured to provide the appropriate current and/or voltage to the unbalanced cell(s) 409A-409C.

In an embodiment, battery cells 409A, 409B, and 409C may be coupled to the DC/DC converter 412 via switches having controls, e.g., K1A, K2A, K3A, K1B, K2B, and K3B. The switches and corresponding controls K1A-K3A and K1B-K3B may be connected to the battery cells 409A-409B via a power circuit 426 and may configured to control power output and/or balance to and from the cells 409A-409C. Loads, e.g., L1, L2, L3, L4, may be connected to the BMC 410. The BMC 410 may be connected to and configured to control each of the switches via controls K1A-K3A and K1B-K3B, having the capability of closing or opening each of the switches. The BMC 410 may control appropriate switches to connect the unbalanced cell(s) to the power circuit 426 to be charged. Upon balancing of the cell(s), the BMC 410 may be configured to recalculate the appropriate current and/or voltage to charge all cells 409A-409C in the battery module 402A.

For example, the BMC 410 may determine that only cell 409A to be unbalanced. Upon calculating appropriate current and/or voltage for the balancing of cell 409A, the BMC 410 may control the DC/DC converter 412 to provide the appropriate current and/or voltage to the power circuit 426. The BMC 410 may be configured to instruct controls K1A and K1B to close their corresponding switches and leave all other switches open, thereby connecting unbalanced cell 409A to the power circuit 426 to be charged by the appropriate current and/or voltage provide by the DC/DC converter 412. In another example, if the BMC 410 determines that only cell 409B is unbalanced, the BMC 410 may instruct controls K2A and K2B to close their corresponding switches and leave all other switches open, thereby connecting unbalanced cell 409B to the power circuit 426 to be charged. Additionally, if only cell 409C is determined to be unbalanced, the BMC 410 may instruct controls K3A and K3B to close their corresponding switches to connect unbalanced cell 409C to the power circuit.

One skilled in the art will understand from the illustrated embodiment that battery cells 409A-409C may be charged simultaneously in various combinations. For instance, if the BMC 410 determines that power levels of cells 409A and 409B are unbalanced, then the BMC 410 may instruct controls K1A and K2B to close their corresponding switches, leaving all other switches open. In this scenario, only cells 409A and 409B will be connected to the power circuit 426 to be charged, while 409C will not be connected. Alternatively, cells 409B and 409C may be connected to the power circuit 426 to be charged while cell 409A is unconnected if the BMC 410 instructs controls K2A and K3B to close their corresponding switches. Additionally, only cells 409A and 409C may be determined to be unbalanced and the BMC 410 may instruct controls K1A, K1B, K3A, and K3B to close their respective switches, thereby connecting cells 409A and 409C to the power circuit 426 to be charged.

Embodiments of the methods described herein may be implemented using a processor and/or other programmable device. To that end, the methods described herein may be implemented on a tangible computer readable medium having instructions stored thereon that when executed the processor and/or other programmable device perform the methods. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

Unless specifically stated otherwise, as apparent from the preceding discussions, it is appreciated that throughout the specification discussions utilizing terms such as “operations,” “processing,” “computing,” “calculating,” “determining,” or the like, refer to the action and/or processes of a computer or computing system, or similar electronic computing device or apparatus, that manipulate and/or transform data represented as physical, such as electronic, quantities within the computing system's registers and/or memories into other data similarly represented as physical quantities within the computing system's memories, registers or other such information storage, transmission or display devices.

“Circuitry”, as used in any embodiment herein, may comprise, for example, singly or in any combination, hardwired circuitry, programmable circuitry, state machine circuitry, and/or firmware that stores instructions executed by programmable circuitry.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

We claim:

1. A system comprising:
a power supply;
at least one battery module configured to receive, store electrical energy from said power supply, and provide said electrical energy to a load, each of said at least one battery module comprising:
at least one battery; and
battery management circuitry (BMC) configured to monitor and detect data received from said at least one battery; and
central control circuitry (CCC) configured to receive data from each BMC of each of said plurality of battery modules and determine at least one requirement of said at least one battery of each of said at least one battery module based on the data received from each BMC.

2. The system of claim 1, wherein said data comprises an indication of a voltage, a current, a state of a battery, a state-of-charge, and a depth-of-discharge from said at least one battery.

3. The system of claim 2, wherein said current is one of a battery discharging current or a battery charging current.

4. The system of claim 1, wherein, when one of said at least one battery module is in a charging period, said CCC is configured to provide a first signal to a corresponding BMC based on a comparison of said data associated with said battery with corresponding information received from said power supply, wherein said BMC is configured to control a bi-directional DC-to-DC converter configured to adjust charging of said at least one battery in response to the first signal.

5. The system of claim 4, wherein the first signal comprises actual charging current and voltage.

6. The system of claim 1, wherein, when one of said at least one battery module is in a discharging period, said CCC is configured to provide a second signal to a corresponding BMC based on a comparison of said data associated with said battery with an amount of power requested from said load, wherein said BMC is configured to control a bi-directional DC-to-DC converter configured to adjust discharging of said at least one battery in response to the second signal.

7. The system of claim 6, wherein the second signal comprises actual discharging current and voltage.

8. The system of claim 1, wherein each BMC is configured to detect an output voltage and current of a corresponding at least one battery of the corresponding battery module.

9. The system of claim 1, wherein each BMC and said CCC are configured to exchange signals in a range of 100 to 500 milliseconds.

10. The system of claim 9, wherein, if a BMC does not receive a signal from said CCC within the range of 100 to 500 milliseconds, said BMC is configured to control a bi-directional DC-to-DC converter configured to adjust voltage output of said at least one battery to a safe voltage and power.

11. A battery module configured to receive and store electrical energy from a power supply and to provide said electrical energy to a load, said battery module comprising:
at least one battery; and
battery management circuitry (BMC) configured to monitor and detect data received from said at least one battery, said BMC configured to provide the data to central control circuitry (CCC);
wherein said central control circuitry is configured to determine at least one requirement of said at least one battery of each of said battery module based on the data received from said BMC.

12. The battery module of claim 11, wherein said data comprises an indication of a voltage, a current, a state of a battery, a state-of-charge, and a depth-of-discharge from said at least one battery.

13. The battery module of claim 12, wherein said detected current is one of a battery discharging current or a battery charging current.

14. The battery module of claim 11, wherein, when said battery module is in a charging period, said CCC is configured to provide a first signal to said BMC based on a comparison of said data associated with said at least one battery with corresponding information received from said power supply, wherein said BMC is configured to control a bi-directional DC-to-DC converter configured to adjust charging of said at least one battery in response to the first signal.

15. The battery module of claim 14, wherein said first signal comprises actual charging current and voltage.

16. The battery module of claim 11, wherein, when said battery module is in a discharging period, said CCC is configured to provide a second signal to said BMC based on a comparison of said data associated with said at least one battery with an amount of power requested from said load, wherein said BMC is configured to control a bi-directional DC-to-DC converter configured to adjust discharging of said at least one battery in response to the second signal.

17. The battery module of claim 16, wherein the second signal comprises actual discharging current and voltage.

18. The battery module of claim 11, wherein the BMC is configured to detect an output voltage and current of said at least one battery of the battery module.

19. The battery module of claim 11, wherein the BMC and said CCC are configured to exchange signals in the range of 100 to 500 milliseconds.

20. The battery module of claim 19, wherein, if said BMC does not receive a signal from said CCC within the range of 100 to 500 milliseconds, said BMC is configured to control a bi-directional DC-to-DC converter configured to adjust voltage output of said at least one battery to a safe voltage and power.

21. A method of balancing a plurality of battery modules, said method comprising:
supplying electrical energy to a plurality of battery modules configured to store and provide said electrical energy to a load, each of said plurality of battery modules comprising at least one battery and battery management circuitry (BMC) configured to monitor and detect data received from said at least one battery;
monitoring said at least one battery of each of said plurality of battery modules via said BMC of each of said plurality of battery modules;
detecting, via said BMC of each of said plurality of battery modules, data received from said at least one battery of each of said plurality of battery modules;
providing, via said BMC of each of said plurality of battery modules, the data to central control circuitry (CCC); and
determining, via said CCC, at least one requirement of said at least one battery of each of said battery module based on the data received from each BMC.

22. The method of claim 21, wherein said data comprises an indication of voltage, a current, a state of a battery, a state-of-charge, and a depth-of-discharge from said at least one battery.

23. The method of claim 21, wherein said detected current is one of a battery discharge current or a battery charging current.

24. The method of claim 21, further comprising, when one of said plurality of battery modules is in a charging period, providing, by said CCC, a first signal to a corresponding BMC based on a comparison of said data associated with said at least one battery of the battery module with corresponding information received from said power supply, wherein said corresponding BMC is configured to control a bi-directional DC-to-DC converter configured to adjust charging of said at least one battery in response to said first signal, where said first signal comprises actual charging current and voltage.

25. The method of claim 21, further comprising, when one of said plurality of battery modules is in a discharging period, providing, by said CCC, a second signal to a corresponding BMC based on a comparison of said data associated with said at least one battery with an amount of power requested from said load, wherein said BMC is configured to control a bi-directional DC-to-DC converter configured to adjust discharging of said at least one battery in response to the second signal comprising actual discharging current and voltage.
